(19) United States
(12) Patent Application Publication
(10) Pub. No.: US 2020/0410578 A1
(43) Pub. Date: Dec. 31, 2020

(54) INFORMATION PROVIDING APPARATUS, INFORMATION PROVIDING SYSTEM, AND INFORMATION PROVIDING METHOD

(71) Applicant: HONDA MOTOR CO., LTD., Tokyo (JP)

(72) Inventors: Ryo Oshima, Wako-shi (JP); Sho Takada, Wako-shi (JP); Nobuyuki Sasaki, Wako-shi (JP); Yoshihiro Matsunaga, Wako-shi (JP); Mitsuhiro Ito, Wako-shi (JP); Mio Oshima, Wako-shi (JP)

(21) Appl. No.: 17/017,232

(22) Filed: Sep. 10, 2020

Related U.S. Application Data
(63) Continuation of application No. PCT/JP2018/043828, filed on Nov. 28, 2018.

(30) Foreign Application Priority Data
Mar. 20, 2018 (JP) 2018-052600

(51) Int. Cl. G06Q 30/06; G06Q 30/02; G06Q 50/06; G06F 16/23; H04W 4/02

(52) U.S. Cl. CPC G06Q 30/0645; G06Q 30/0283; H04W 4/023; G06F 16/235; G06Q 50/06

(57) ABSTRACT

An information providing apparatus receives an information request concerning a dealer or rental trader holding a lendable electric power supply device from a terminal via a network, acquires information about a lendable electric power supply device by accessing a database configured to manage information about the lendable electric power supply device which includes an electric generator and a rechargeable battery that can be charged by electric power generated by the electric generator, and information about the lent electric power supply device and a lending period to be updated along with an elapse of time during lending of the electric power supply device, edits information to be provided to the terminal that has issued the information request, based on the acquired information, and transmits the edited information to the terminal that has issued the information request, via the network.

### CROSS-REFERENCE TO RELATED APPLICATION(S)

This application is a continuation of International Patent Application No. PCT/JP2018/043828 filed on Nov. 28, 2018, which claims priority to and the benefit of Japanese Patent Application No. 2018-052600 filed on Mar. 20, 2018, the entire disclosures of which are incorporated herein by reference.

### BACKGROUND OF THE INVENTION

### Field of the Invention

The present invention relates to an information providing apparatus, an information providing system, and an information providing method and, more particularly, to an information providing apparatus, an information providing system, and an information providing method for providing, for example, the location situation of electric power supply devices to a user via a network.

### Description of the Related Art

There has conventionally been proposed a system that provides, to a user who needs electric power, for example, a person who is driving an electric vehicle (EV), information about locations of facilities such as charging stations capable of supplying electric power to the electric vehicle. For example, Japanese Patent Laid-Open No. 2013-104680 proposes a system that checks the remaining battery amount of an EV and charging stations reachable using the remaining battery amount and displays the result on the display of the EV.

However, the above-described prior art has proposed a system that supplies electric power itself to an appliance held by a user, and an appliance capable of supplying electric power is not provided or lent to the user.

On the other hand, it is sometimes convenient for the user to borrow an electric power supply appliance such as a movable electric generator or an electric storage device itself and receive electric power supply via the appliance or the device. For example, this corresponds to a case in which the user wants to use an electric generator or an electric storage device when going to auto-camping, or a case in which blackout occurs in a disaster, and immediate electric power supply is needed. In this case, it is demanded to quickly acquire information representing a dealer or a rental trader from which such an electric power supply device can be borrowed.

### SUMMARY OF THE INVENTION

The present invention has been made in consideration of the above-described related art, and has as its objective to provide an information providing apparatus, an information providing system, and an information providing method capable of providing information about, for example, a dealer or a rental trader that manages and holds lendable electric power supply devices.

In order to achieve the above-described objective, an information providing apparatus according to the present invention has the following arrangement.

That is, according to one aspect of the present invention, there is provided an information providing apparatus for providing information via a network in response to a request from a terminal, comprising a reception unit configured to receive, from the terminal via the network, an information request concerning one of a dealer and a rental trader, which holds a lendable electric power supply device, a database configured to manage information about an electric power supply device that is lendable by one of the dealer and the rental trader and includes an electric generator and a rechargeable battery that can be charged by electric power generated by the electric generator, and information about the lent electric power supply device and a lending period to be updated along with an elapse of time during lending of the electric power supply device, an acquisition unit configured to acquire the information about the electric power supply device that is lendable by one of the dealer and the rental trader by accessing the database, an editing unit configured to edit, based on information acquired by the acquisition unit, information to be provided to the terminal that has issued the information request, and a transmission unit configured to transmit, via the network, the information edited by the editing unit to the terminal that has issued the information request.

According to another aspect of the present invention, there is provided an information providing system comprising the above information providing apparatus, a terminal of a user, which is connected to the information providing apparatus via a network, and an information processing apparatus connected to the information providing apparatus via one of the network and a dedicated line and configured to perform a lending procedure and a return procedure of an electric power supply device.

According to still another aspect of the present invention, there is provided an information providing method in an information providing apparatus for providing information via a network in response to a request from a terminal, comprising receiving, from the terminal via the network, an information request concerning one of a dealer and a rental trader, which holds a lendable electric power supply device, acquiring information about an electric power supply device that is lendable by one of the dealer and the rental trader by accessing a database configured to manage information about the electric power supply device that is lendable by one of the dealer and the rental trader and includes an electric generator and a rechargeable battery that can be charged by electric power generated by the electric generator, and information about the lent electric power supply device and a lending period to be updated along with an elapse of time during lending of the electric power supply device, editing, based on the acquired information, information to be provided to the terminal that has issued the information request, and transmitting, via the network, the edited information to the terminal that has issued the information request.

Hence, according to the arrangements of the above aspects of the present invention, the location of, for example, a dealer or a rental trader that manages and holds a lendable electric power supply device including an electric generator and a rechargeable battery that can be charged by electric power generated by the electric generator can be provided to a terminal that has requested the information.

Further features of the present invention will become apparent from the following description of exemplary embodiments (with reference to the attached drawings).

### BRIEF DESCRIPTION OF THE DRAWINGS

FIG. 1 is a block diagram showing the outline of the arrangement of an information providing system according to a representative embodiment of the present invention;

FIG. 2 is a block diagram showing the arrangement of an electric power supply device;

FIG. 3 is a block diagram showing the schematic arrangement of an information providing apparatus;

FIG. 4 is a view showing lending/borrowing information stored in a database provided in an information providing apparatus;

FIG. 5 is a flowchart showing the outline of overall processing of information providing executed by the information providing system;

FIG. 6A is a flowchart showing details of information generation processing and database updating processing; and

FIG. 6B is a flowchart showing details of information generation processing and database updating processing.

### DESCRIPTION OF THE EMBODIMENTS

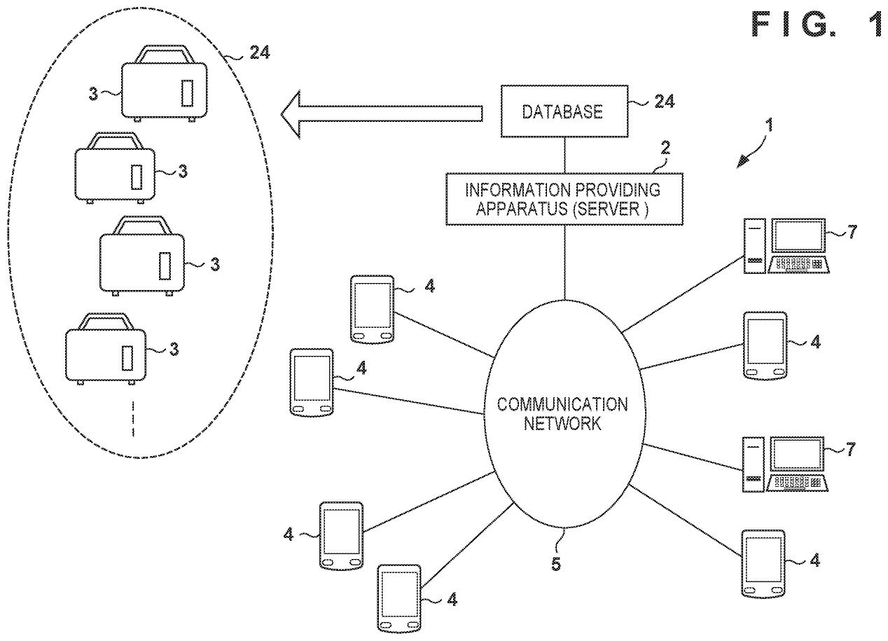

A preferred embodiment of the present invention will now be described in more detail with reference to the accompanying drawings.

<Arrangement of System (FIG. 1)>

FIG. 1 is a block diagram showing the outline of the arrangement of an information providing system 1 according to a representative embodiment of the present invention.

The information providing system 1 shown in FIG. 1 includes, for example, an information providing apparatus 2 communicably connected via a communication network 5 such as the Internet, and a plurality of terminals 4.

The information providing apparatus 2 is a computer functioning as an information providing server (to be referred to as a server hereinafter) in the information providing system 1. The information providing apparatus 2 includes a database (DB) 24 that manages information about lendable electric power supply devices 3. In the example shown in FIG. 1, four electric power supply devices are shown as the electric power supply devices 3 managed in the database 24. However, a number of electric power supply devices 3 are managed, as a matter of course.

The electric power supply device 3 is a device that supplies electric power to an electric appliance. In this embodiment, the electric power supply device is assumed to be a movable electric power supply device, but may be a stationary electric power supply device. The movable electric power supply device can be carried to a use site in accordance with a user's application purpose such as leisure, business, or emergency. The electric power supply device 3 can be either a device that the manufacturer of the electric power supply device can lend or a rental article of a dealer or a rental trader. A detailed arrangement of the electric power supply device 3 will be described later.

The terminal 4 is a computer used by the user of the electric power supply device 3, and is, for example, a personal computer or a portable terminal such as a smartphone or a tablet. The terminal 4 includes a display or a touch panel, and has a wireless communication function such as WiFi®, Bluetooth®, or LTE. In this embodiment, information to be provided to the user of the terminal 4 is transmitted from the information providing apparatus 2 (server) to the terminal 4 via the communication network 5.

In addition, a terminal 7 is a computer connected to the information providing apparatus 2 via the communication network 5 and used by a dealer or a rental trader that holds and manages the lendable electric power supply devices 3, and is, for example, an information processing apparatus such as a personal computer (PC) or a POS terminal. Note that the terminal 7 may communicate with the information providing apparatus 2 not via a public line shown as the communication network 5 but via a dedicated line.

Hence, in the information providing system 1, the information providing apparatus 2 collects information including the situations of lending and return of the electric power supply device 3 from a dealer or a rental trader that owns the electric power supply device 3 via a dedicated line or the public communication network 5 such as the Internet. Based on the information collected by the information providing apparatus 2, the database 24 is updated and managed in a latest state. By accessing the database 24, information including the location of the dealer or the rental trader that holds and manages the lendable electric power supply devices 3 is provided to the terminal 4. Based on the provided information, the terminal 4 can understand the type and location of an apparatus preferable for the user who wishes to borrow the apparatus.

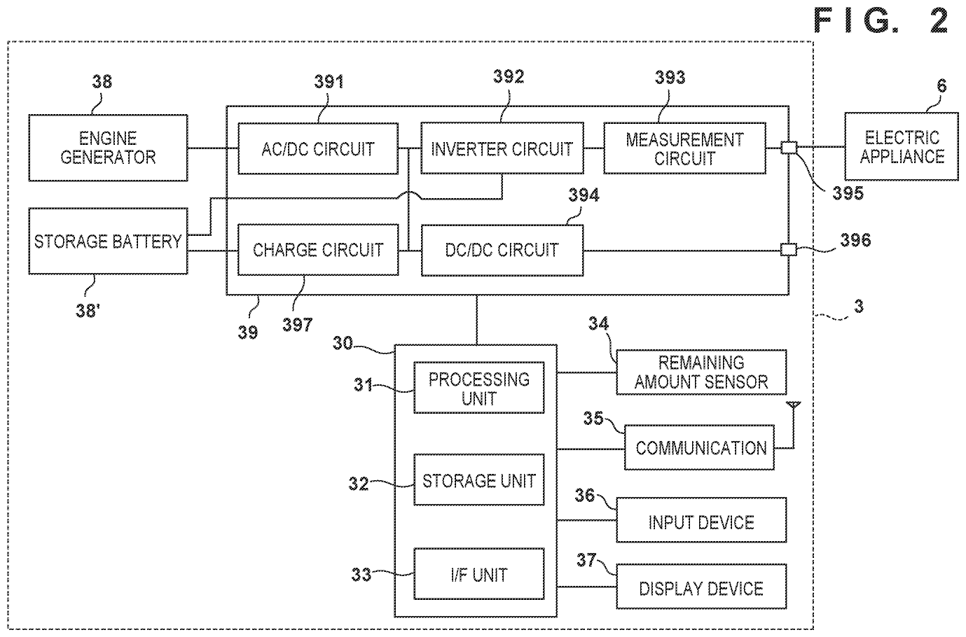

The information providing apparatus 2 can be operated by, for example, the rental trader of the electric power supply device 3, the dealer of the electric power supply device 3, or the manufacturer of the electric power supply device 3. The traders can obtain information concerning the actual rental state of the electric power supply device 3 and can use the information as a material for business in the future.

<Electric Power Supply Device (FIG. 2)>

FIG. 2 is a block diagram showing the arrangement of the electric power supply device 3.

The electric power supply device 3 according to this embodiment is an electric power supply device including both an engine generator 38 and a rechargeable battery 38′. Hence, the electric power supply device 3 can supply electric power stored in the rechargeable battery 38′ to an electric appliance 6 even after the fuel of the engine generator 38 has run out. The engine generator 38 is driven by fuel and generates AC power. The fuel is, for example, gasoline, liquefied petroleum gas, hydrogen, or the like. The rechargeable battery 38′ is, for example, a secondary battery such as a lithium ion battery.

A power supply circuit 39 is a circuit that transforms a voltage generated by the engine generator 38 into a predetermined alternating current or direct current. An AC/DC circuit 391 includes a rectifying smoothing circuit that rectifies and smooths the alternating current generated by the engine generator 38, and the like. An inverter circuit 392 is a circuit that transforms the direct current output from the AC/DC circuit 391 into a stable alternating current having a predetermined frequency. The inverter circuit 392 also transforms the direct current generated by the AC/DC circuit 391 or the direct current supplied from the rechargeable battery 38′ into an alternating current. The rechargeable battery 38′ outputs a DC voltage of, for example, 48 V to the inverter circuit 392 or a DC/DC circuit 394.

A measurement circuit 393 includes a current sensor and a voltage sensor, measures an AC voltage and an alternating current supplied from the inverter circuit 392 to the electric appliance 6 connected to an AC outlet 395, and outputs the measurement result to a control circuit 30. The electric appliance 6 that can be driven by AC power is detachably connected to the AC outlet 395. If the application purpose of the electric power supply device 3 is leisure, examples of the electric appliance 6 are electric loads such as a cooking device, an air conditioner, a television, a lighting device, and a dryer. Examples of cooking devices are an electric griddle, a kettle, a microwave oven, a grill, and a mixer. If the application purpose of the electric power supply device 3 is business, examples are electric loads such as an electric tool, a large lighting device, and a compressor.

In this arrangement, the measurement circuit 393 measures information concerning the life of the rechargeable battery 38′, charge/discharge information, charge/discharge frequency, the presence/absence of overcharge/overdischarge, the remaining amount of the rechargeable battery 38′ at the start of charge, the remaining amount at the end of charge, and the like.

A DC/DC circuit 394 transforms the level of a DC voltage output from the AC/DC circuit 391 and supplies an operating voltage to the control circuit 30 or the like, or outputs the voltage from a DC outlet 396. The electric appliance 6 that can be driven by DC power is detachably connected to the DC outlet 396.

A charge circuit 397 charges the rechargeable battery 38′ based on the electric power generated by the engine generator 38.

The control circuit 30 is a circuit that controls the electric power supply device 3. The control circuit 30 includes a processing unit 31, a storage unit 32, and an I/F (interface) unit 33. The processing unit 31 is a processor represented by a CPU or an MPU, and executes programs stored in the storage unit (memory) 32. The storage unit 32 is a storage device such as a RAM, a ROM, an SSD (Solid State Disk), or a hard disk. In addition to the programs to be executed by the processing unit 31, various kinds of data are stored in the storage unit 32. The I/F unit 33 relays transmission/reception of signals between an external device and the processing unit 31.

A remaining amount sensor 34 detects the remaining amount of the fuel of the engine generator 38 and the remaining capacity of the rechargeable battery 38′. The remaining amount sensor 34 can be provided in a fuel tank that stores fuel or in the rechargeable battery 38′. The fuel efficiency of the engine generator 38 can be calculated based on the fuel consumption detected by the remaining amount sensor 34 and the power consumption of the electric appliance 6 measured by the measurement circuit 393.

A communication device 35 is a wireless communication device that performs information communication via the communication network 5. Note that the communication device 35 may be a wired communication device. An input device 36 is a device that accepts operation input of the user of the electric power supply device 3, and includes, for example, a plurality of switches or a piezoelectric touch panel. A display device 37 is a device that displays information to the user of the electric power supply device 3, and is, for example, a light emitting element such as an LCD or an LED.

The measurement result of the measurement circuit 393 can be used as information concerning the type of the electric appliance 6 connected to the AC outlet 395 of the electric power supply device 3, and can particularly be used to estimate the type. Electric power supplied to the electric appliance 6 exhibits a waveform characterized by the type of the electric appliance 6. By the feature amount, the type of the connected electric appliance 6 can be estimated.

<Another Arrangement Example of Electric Power Supply Device>

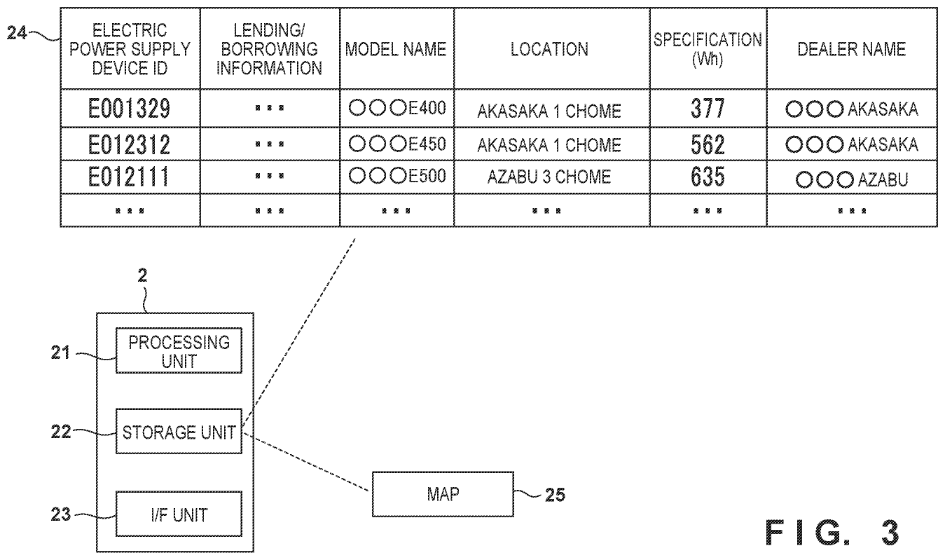

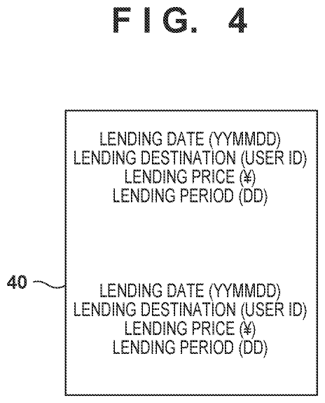

The electric power supply device 3 shown in FIG. 2 includes both the engine generator 38 and the rechargeable battery 38′. However, the present invention is not limited to this. For example, the electric power supply device 3 may include only the rechargeable battery 38′ as the electric power supply source without including the engine generator 38, the AC/DC circuit 391, and the charge circuit 397.

<Information Providing Apparatus (FIGS. 3 and 4)>

FIG. 3 is a block diagram showing the schematic arrangement of the information providing apparatus 2.

The information providing apparatus 2 includes a processing unit 21, a storage unit 22, and an IF (interface) unit 23. The processing unit 21 is a processor represented by a CPU, and executes programs stored in the storage unit 22. The I/F unit 23 relays transmission/reception of signals between an external device and the processing unit 21. The I/F unit 23 includes a wired or wireless communication interface capable of communicating with a dealer, a rental trader, or the terminal 4 via the communication network 5 or a dedicated line. The storage unit 22 is a storage device such as a RAM, a ROM, an SSD, or a hard disk.

In addition to the programs to be executed by the processing unit 21, various kinds of data are stored in the storage unit 22. In the example shown in FIG. 3, databases 24 and 25 are shown as the data stored in the storage unit 22. The database 24 is a database that accumulates data concerning the electric power supply device 3. The database (map) 25 stores map information associated with the locations of the electric power supply devices 3 managed in the database 24.

“Electric power supply device ID” is an identifier assigned in advance to specify each electric power supply device 3. “Model name” represents the model number of the electric power supply device 3, and “location” represents the location of the electric power supply device 3. “Specifications” includes information concerning the specifications of the electric power supply device 3, for example, the rated output, the continuous operable time, and the like. “Dealer name” includes the name of a dealer or rental trader that manages the electric power supply device 3. “Lending/borrowing information” includes information representing the history of lending and borrowing of the electric power supply device 3.

The database 25 is a database that accumulates a map (map information). Based on position information transmitted from the terminal 4, the processing unit 21 collates the location of the electric power supply device 3, which is to be provided to the terminal 4, with the map information and provides accurate position information to the user of the terminal 4.

FIG. 4 is a view showing lending/borrowing information stored in the database 24 provided in the information providing apparatus 2.

In the database 24, lending/borrowing information is managed for each electric power supply device.

The lending/borrowing information is generated every time one lending operation and one returning operation are performed, and the history information of lending/borrowing is accumulated. As for the format of the lending/borrowing history, as shown in FIG. 4, every time lending or return occurs, at least pieces of information of the lending date, lending destination, lending price, and the lending period are generated or updated, and stored time-serially. In particular, as for the lending period, during lending, information representing lending is updated by incrementing the number of days by “+1” every time one day elapses. When a device is returned, the number of days of the lending period is set to 0. This allows the information providing apparatus 2 that accesses the database (DB) 24 to know which electric power supply device 3 is being lent, and which electric power supply device 3 is lendable.

Note that as for the arrangement of the terminal 4, an off-the-shelf portable terminal or personal computer (PC) suffices, and a description thereof will be omitted. However, it is assumed that an application configured to cause the user to acquire the information of the electric power supply device via the network is downloaded in the portable terminal or the PC. In addition, the portable terminal or the PC can acquire its position information via a GPS. Map information is provided from the information providing apparatus 2 or another information supply source, and the portable terminal can display a map and the position information.

Processing of providing information of a lendable electric power supply device, which is executed by the information providing system with the above-described arrangement, will be described next with reference to a flowchart.

### Processing Examples

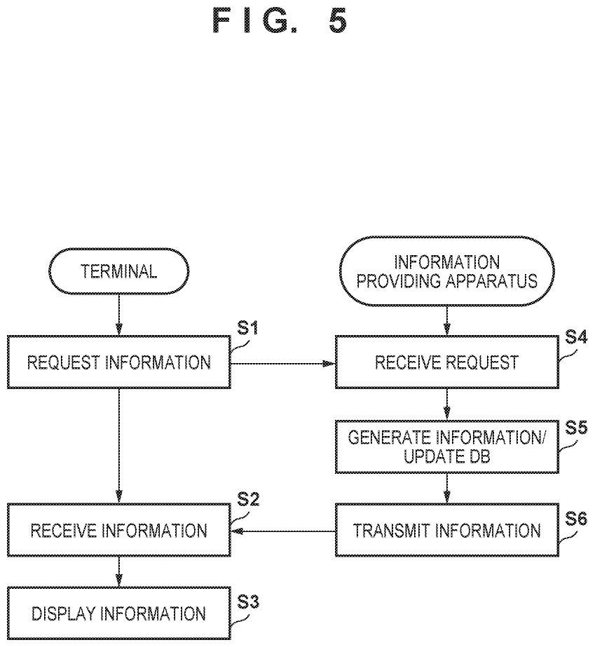

FIG. 5 is a flowchart showing the outline of overall processing of information providing executed by the information providing system 1.

According to FIG. 5, first, in step S1, the user of the terminal 4 activates the application, and requests the information providing apparatus (server) 2 to provide the information of a lendable electric power supply device via the communication network 5. The request includes the position information of the terminal 4 itself. For the request, the information providing apparatus 2 receives the request in step S4, and generates information to be provided to the terminal 4 and updates the database (DB) 24 in step S5.

In step S6, the generated information is transmitted to the terminal 4 that has transmitted the request via the communication network 5.

On the other hand, the terminal 4 receives the transmitted information in step S2, and displays the received information (the information of the lendable electric power supply device) in step S3. In this information display, the names and locations of (a plurality of) dealers or rental traders that exist in the neighborhood of the terminal 4 and can lend electric power supply devices are displayed in a table format on the display of the terminal 4. When the position of a displayed dealer or rental trader is tapped, the number of electric power supply devices that the dealer or rental trader can lend, the lending price, the specifications, and the like are displayed.

In addition, if the terminal 4 can display a map based on the map information, the position of the terminal 4 itself and the locations of (a plurality of) dealers or rental traders that exist in the neighborhood and can lend electric power supply devices may be displayed as icons on the map. When the icon of a displayed dealer or rental trader is tapped, pieces of detailed information such as the accurate position of the tapped dealer or rental trader, and the number of electric power supply devices that the dealer or rental trader can lend, the lending price, and the specifications are preferably displayed.

Generation processing of information to be provided to the terminal and database updating processing will be described next.

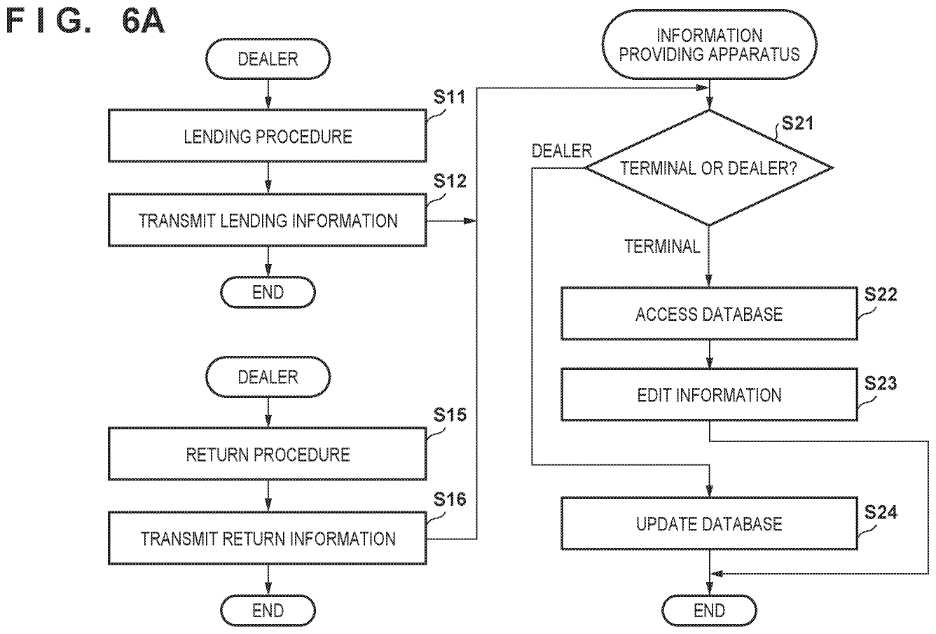

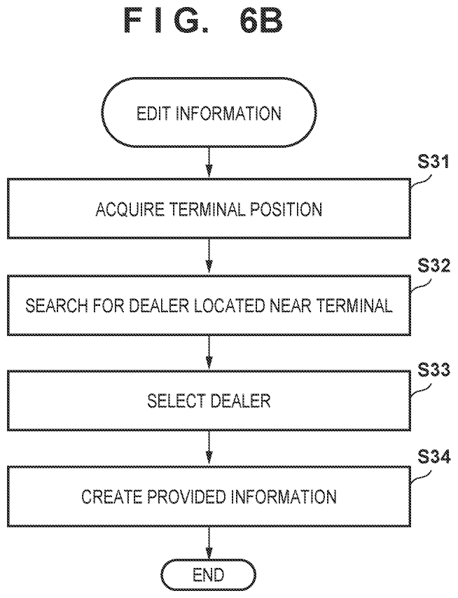

FIGS. 6A and 6B are flowcharts showing details of information generation processing and database updating processing.

According to FIG. 6A, upon receiving an information request in step S4 shown in FIG. 5, in step S21, it is checked whether the transmission source of the received information is a terminal, or a dealer or rental trader. If the transmission source is a terminal, the process advances to step S22 to access the database 24 and acquire information necessary for subsequent information editing. The information acquired here is information concerning electric power supply devices in a lendable state.

Note that as for the information to be acquired, a dealer or rental trader located near the terminal 4 is preferably selected based on the location of the dealer or rental trader, which is stored in the database 24 in advance, and the position information of the terminal 4 that has issued the information request. Instead of making such selection, all electric power supply devices managed by the database 24 may be set to targets and selected later.

In step S23, information to be transmitted to the terminal 4 that has issued the information request is edited based on the acquired information.

In this information editing, as shown in FIG. 6B, in step S31, the position information of the terminal 4 that has issued the information request is acquired. Also, in step S32, a dealer or a rental trader located near the terminal 4 is searched for. In step S33, a dealer or a rental trader as the target of information to be transmitted to the terminal 4 is selected.

In step S34, information to be provided to the terminal 4 is created based on the processes of steps S31 to S33. The provided information includes the location of the dealer or the rental trader selected in step S33, electric power supply devices that the dealer or rental trader can lend, the number of devices, the lending price, and the specifications.

When the information editing in step S23 ends, the processing ends.

If the transmission source is the information processing apparatus 7 of a dealer or a rental trader in step S21, the process advances to step S24 to update the database 24 to the latest state.

As shown in FIG. 6A, a dealer or a rental trader performs an actual lending operation of an electric power supply device under the management. For lending, in step S11, a lending procedure is performed using the information processing apparatus 7 of the dealer or the rental trader. In step S12, lending information is transmitted to the information providing apparatus 2 via a dedicated line or the communication network 5. On the other hand, for return, in step S15, a return procedure is performed using the information processing apparatus 7 of the dealer or the rental trader. In step S16, return information is transmitted to the information providing apparatus 2 via a dedicated line or the communication network 5.

Upon receiving the lending information or return information, the information providing apparatus 2 determines in step S21 that the information transmission source is the dealer or the rental trader. The process advances to step S24 to access the database 24 and update the contents.

Here, if lending information is received, the lending/borrowing information of the electric power supply device ID of the lent electric power supply device 3 in the database (DB) 24 is updated. That is, the pieces of information of the lending date and the lending destination shown in FIG. 4 are updated, and “1” is set as the initial value to the lending period to indicate that the electric power supply device is being lent. In addition, the number of days is incremented by “+1” every time one day elapses as the lending period. On the other hand, if return information is received, the lending/borrowing information of the electric power supply device ID of the returned electric power supply device 3 in the database (DB) 24 is updated. That is, in the lending period shown in FIG. 4, “0” is set to the number of days of the actual lending period. After that, the electric power supply device is managed in a lendable state.

Hence, according to the above-described embodiment, in the information providing system, the location of a dealer or a rental trader that exists near the terminal and can lend an electric power supply device and the number of lendable electric power supply devices, the lending price, and the specifications can be notified in accordance with a request from the terminal. The terminal can display the notified information in a table format or on a map. This allows the user of the terminal to easily acquire information concerning a lendable electric power supply device.

### Summary of Embodiment

Arrangement 1.

An information providing apparatus (2) for providing information via a network (5) in response to a request from a terminal (4), comprises a reception unit (23) configured to receive, from the terminal via the network, an information request conceming one of a dealer and a rental trader, which holds a lendable electric power supply device, a database (24) configured to manage information about an electric power supply device lendable by one of the dealer and the rental trader, an acquisition unit (21) configured to acquire the information about the electric power supply device that is lendable by one of the dealer and the rental trader by accessing the database, an editing unit (21) configured to edit, based on information acquired by the acquisition unit, information to be provided to the terminal that has issued the information request, and a transmission unit (23) configured to transmit, via the network, the information edited by the editing unit to the terminal that has issued the information request.

Arrangement 2.

The information request (S1) received by the reception unit includes information representing a position of the terminal that has issued the information request.

Arrangement 3.

The database (24) stores at least one of a dealer name and a rental trader name, which holds the lendable electric power supply device, a location of one of the dealer and the rental trader, an identifier for specifying each lendable electric power supply device, a model name of each lendable electric power supply device, and lending/borrowing information of each lendable electric power supply device.

Arrangement 4.

The information edited by the editing unit includes a location of one of the dealer and the rental trader, which is located near the terminal that has issued the information request, model names, specifications, and the number of electric power supply devices that are lendable by one of the dealer and the rental trader, and the lending price of the electric power supply device.

Arrangement 5.

The lending/borrowing information is history information (40) that is updated every time lending or return is performed, and the history information includes a lending date, a lending destination, a lending price, and a lending period.

Arrangement 6.

The reception unit further receives information concerning lending and return of the electric power supply device from an information processing apparatus of one of the dealer and the rental trader (S12, S16), and the information managed by the database is updated, based on the information concerning lending and return of the electric power supply device, which is received by the reception unit, every time the electric power supply device is lent or returned in one of the dealer and the rental trader (S24).

Arrangement 7.

The electric power supply device (3) includes an electric generator (38) and a rechargeable battery (38′) that can be charged by electric power generated by the electric generator, or includes a rechargeable battery (38′) that can be charged.

Arrangement 8.

An information providing system (1) comprises an information providing apparatus (2) of any one of Arrangements 1 to 7, a terminal (4) of a user, which is connected to the information providing apparatus via a network (5), and an information processing apparatus (7) connected to the information providing apparatus via one of the network and a dedicated line and configured to perform a lending procedure and a return procedure of an electric power supply device.

Arrangement 9.

An information providing method in an information providing apparatus (2) for providing information via a network (5) in response to a request from a terminal (4), comprises receiving (S4), from the terminal via the network, an information request conceming one of a dealer and a rental trader, which holds a lendable electric power supply device, acquiring (S5) information about an electric power supply device that is lendable by one of the dealer and the rental trader by accessing a database configured to manage information about an electric power supply device lendable by one of the dealer and the rental trader, editing (S23), based on the acquired information, information to be provided to the terminal that has issued the information request, and transmitting (S6), via the network, the edited information to the terminal that has issued the information request.

According to Arrangement 1 to Arrangement 9 described above, it is possible to provide, via the network, information concerning a dealer or a rental trader that manages and holds lendable electric power supply devices.

According to Arrangement 2 to Arrangement 4 described above, it is possible to provide information including the location of a dealer or a rental trader that is located near the terminal and lends an electric power supply device and the specifications and number of lendable electric power supply devices.

According to Arrangement 5 to Arrangement 6, the lending/borrowing information managed by the database can always hold the latest state.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information providing apparatus for providing information via a network in response to a request from a terminal, comprising:
a reception unit configured to receive, from the terminal via the network, an information request concerning one of a dealer and a rental trader, which holds a lendable electric power supply device;
a database configured to manage information about an electric power supply device that is lendable by one of the dealer and the rental trader and includes an electric generator and a rechargeable battery that can be charged by electric power generated by the electric generator, and information about the lent electric power supply device and a lending period to be updated along with an elapse of time during lending of the electric power supply device;
an acquisition unit configured to acquire the information about the electric power supply device that is lendable by one of the dealer and the rental trader by accessing the database;
an editing unit configured to edit, based on information acquired by the acquisition unit, information to be provided to the terminal that has issued the information request; and
a transmission unit configured to transmit, via the network, the information edited by the editing unit to the terminal that has issued the information request.

2. The information providing apparatus according to claim 1, wherein the information request received by the reception unit includes information representing a position of the terminal that has issued the information request.

3. The information providing apparatus according to claim 1, wherein the database stores at least
one of a dealer name and a rental trader name, which holds the lendable electric power supply device,
a location of one of the dealer and the rental trader,
an identifier for specifying each lendable electric power supply device,
a model name of each lendable electric power supply device, and
lending/borrowing information including a lending date, a lending destination, a lending price, and the lending period of each lent electric power supply device.

4. The information providing apparatus according to claim 3, wherein the information edited by the editing unit includes a location of one of the dealer and the rental trader, which is located near the terminal that has issued the information request, model names, specifications, and the number of electric power supply devices that are lendable by one of the dealer and the rental trader, and the lending price of the electric power supply device.

5. The information providing apparatus according to claim 3, wherein the lending/borrowing information is history information that is updated every time lending or return is performed, and
the lending period is updated to be incremented by “+1” every day during lending, and is set to “0” by return.

6. The information providing apparatus according to claim 1, wherein the reception unit further receives information concerning lending and return of the electric power supply device from an information processing apparatus of one of the dealer and the rental trader, and
the information managed by the database is updated, based on the information, concerning lending and return of the electric power supply device, which is received by the reception unit, every time the electric power supply device is lent or returned in one of the dealer and the rental trader.

7. An information providing system comprising:
an information providing apparatus;
a terminal of a user, which is connected to the information providing apparatus via a network; and
an information processing apparatus connected to the information providing apparatus via one of the network and a dedicated line and configured to perform a lending procedure and a return procedure of an electric power supply device, wherein
the information providing apparatus provides information via the network in response to a request from the terminal,
the information providing apparatus comprises:
a reception unit configured to receive, from the terminal via the network, an information request concerning one of a dealer and a rental trader, which holds a lendable electric power supply device;
a database configured to manage information about an electric power supply device that is lendable by one of the dealer and the rental trader and includes an electric generator and a rechargeable battery that can be charged by electric power generated by the electric generator, and information about the lent electric power supply device and a lending period to be updated along with an elapse of time during lending of the electric power supply device;
an acquisition unit configured to acquire the information about the electric power supply device that is lendable by one of the dealer and the rental trader by accessing the database;
an editing unit configured to edit, based on information acquired by the acquisition unit, information to be provided to the terminal that has issued the information request; and
a transmission unit configured to transmit, via the network, the information edited by the editing unit to the terminal that has issued the information request.

8. An information providing method in an information providing apparatus for providing information via a network in response to a request from a terminal, comprising:
receiving, from the terminal via the network, an information request concerning one of a dealer and a rental trader, which holds a lendable electric power supply device;
acquiring information about an electric power supply device that is lendable by one of the dealer and the rental trader by accessing a database configured to manage information about the electric power supply device that is lendable by one of the dealer and the rental trader and includes an electric generator and a rechargeable battery that can be charged by electric power generated by the electric generator, and information about the lent electric power supply device and a lending period to be updated along with an elapse of time during lending of the electric power supply device;
editing, based on the acquired information, information to be provided to the terminal that has issued the information request; and
transmitting, via the network, the edited information to the terminal that has issued the information request.
